(19) United States
(12) Patent Application Publication
(10) Pub. No.: US 2007/0092668 A1
(43) Pub. Date: Apr. 26, 2007

(54) Inkjet-receptive article

(75) Inventor: David K. Hood, Basking Ridge, NJ (US)

Correspondence Address: William J. Davis, Esq.;INTERNATIONAL SPECIALTY PRODUCTS, Legal Department, Building No. 8-2, 1361 Alps Road, Wayne, NJ, 07470, US

(73) Assignee: ISP INVESTMENTS INC.

(21) Appl. No.: 11/546,067

(22) Filed: Oct. 11, 2006

Related U.S. Application Data
(60) Provisional application No. 60/730,133, filed on Oct. 25, 2005.

(51) Int. Cl. B41M 5/40

(52) U.S. Cl. 428/32.38

(57) ABSTRACT

An inkjet-receptive article includes a substrate having a coating thereon which is a vinyl lactam polymer or copolymer.

### CROSS-REFERENCE TO RELATED U.S. PATENT APPLICATIONS

This application corresponds to U.S. Provisional Patent Application Ser. No. 60/730,133, filed Oct. 25, 2005, the complete disclosure of which is hereby incorporated by reference.

### BACKGROUND OF THE INVENTION

1. Field of the Invention

This invention relates to inkjet printing, and, more particularly, to an inkjet-receptive article which includes a substrate coated with a vinyl lactam polymer or copolymer.

2. Description of the Prior Art

Inkjet printing on paper has attained considerable commercial success in the computer industry. However, inkjet printing onto substrates such as plastics, e.g. vinyl, polyester or polyolefin, and the like, has not attained the print quality, print integrity and adhesion commonly recognized as standards for paper substrates.

Accordingly, it is an object of this invention to provide an inkjet-receptive article which includes a plastic substrate coated with a vinyl lactam polymer or copolymer, having advantageous properties suitable for commercial use.

Another object herein is to provide such an article which is both solvent-based and water-based ink printable.

Still another object herein is to provide a suitable composition for forming an inkjet-receptive coating on a plastic substrate.

### SUMMARY OF THE INVENTION

What is described herein is an inkjet-receptive article comprising a substrate having a coating thereon comprising a vinyl lactam polymer or copolymer.

Preferably, the vinyl lactam polymer is a polyvinylpyrrolidone or polyvinyl caprolactam polymer or copolymer, most preferably, polyvinylpyrrolidone-vinyl acetate (PVP-VA). Other suitable comonomers include dimethylaminopropyl methacrylamide (DMAPMA) and dimethylaminoethyl methacrylate (DMAEMA).

Preferably, the substrate is a plastic, e.g. a vinyl, polyester or polyolefin.

Suitably, the inkjet-receptive article includes a pigment, e.g. silica or barium sulfate, or mixtures thereof, suitably present in an amount of up to 30 wt. % of the coating, preferably, 5-15 wt. % of the coating.

Suitably, the inkjet-receptive article includes a diluent, e.g. a polymer resin, as a powder or solution, present in an amount of up to 40 wt. % of the coating, preferably 5-15 wt. %.

Optionally, the ink-receptive article includes a surfactant, suitably present in amount of up to 4 wt. % of the coating.

In another embodiment of the invention, there is provided a solvent-based composition for forming an inkjet-receptive coating on a substrate comprising:

(a) a vinyl lactam polymer or copolymer,

(b) a non-aqueous solvent,

(c) optionally a pigment, and

(d) a polymer resin diluent.

Optionally, the composition includes a surfactant.

Suitably, the solvent-based composition has a % solids of 8-50%, preferably 20-30%.

Suitably, the solvent-based composition has a Brookfield viscosity of 50-1500 cPs (LVD-It, #61, 30 rpm, 31% scale), preferably 60-500 cPs.

Suitable copolymers of polymer resin diluents include vinyl chloride/vinyl acetate, a carboxyl-modified vinyl copolymer, an epoxy-modified vinyl copolymer, and a hydroxyl-modified vinyl copolymer, e.g. Dow/UCAR resins.

Generally, (a) is a powder or present in a non-aqueous solution; (b) is an alcohol, ester, ketone, or mixtures thereof; e.g. methyl ethyl ketone, isopropanol, ethanol or isopropyl acetate, or mixtures thereof; and (c) is silicon dioxide, and (d) is a resin, or mixtures thereof.

A process is described herein for making the inkjet-receptive article which comprises applying the solvent-based composition to a plastic substrate, and drying to remove the non-aqueous solvent.

The polymer diluent of the invention has tough, durable, flexible, film-forming properties, as well as improved adhesion to the substrate and reduced tack.

### DETAILED DESCRIPTION OF THE INVENTION

### EXAMPLE 1

### Solvent-Based Composition for Inkjet-Printing onto Plastic Substrates

Vinyl Film Prototype Preparation (Solvent-Based):

The coating solution had a solids content of about 24% and a viscosity of 62 cPs using a Brookfield viscometer (LV DV-1+, #61, 30 rpm, 31 % scale).

The single layer coating was prepared as follows:
Step 1: Dissolved 2 g of VAGD solid resin diluent (Dow/UCAR*) in 8 g of MEK.
Step 2: Added an additional 45 g of MEK.
Step 3: Added 45 g of E535 PVP/VA (ISP) (in ethanol).
Step 4: Added 0.02 g Surfadone® LP-100 (ISP) (octyl pyrrolidone).
   *Acetic acid ethenyl ester polymer with chloroethene and ethanol (solid powder).

The coating solution was coated onto vinyl and dried in an air oven at ˜90° C. for about 5 minutes.

### EXAMPLE 2

Vinvl Solvent Coating Compositions*

| | | | | Solid | % in Dry |
|---|---|---|---|---|---|
| Product | Supplier | Mass | % Solids | Mass(g) | Composition |
| MEK | Aldrich | 53 | | | |
| UCAR | Dow | 2 | 100 | 2 | 8.1 |
| VAGD | | | | | |
| PVP/VA | ISP | 45 | 50 | 22.5 | 91.8 |
| E-535 | | | | | |
| Surfadone | ISP | 0.02 | 100 | 0.02 | 0.1 |
| LP-100 | | | | | |
| Total | | 100.02 | | 24.42 | |

*Percent Solids of Coating is ˜24.5

### EXAMPLE 3*

| | | | | Solid | % in Dry |
|---|---|---|---|---|---|
| Product | Supplier | Mass | % Solids | Mass(g) | Composition |
| MEK | Aldrich | 53 | | | |
| UCAR | Dow | 2 | 100 | 2 | 7.5 |
| VAGD | | | | | |
| PVP/VA | ISP | 45 | 50 | 22.5 | 22.1 |
| E-535 | | | | | |
| SiLCRON | ISP | 2 | 100 | 2 | 7.5 |
| G-100 | | | | | |
| Surfadone | ISP | 0.02 | 100 | 0.02 | 0.1 |
| LP-100 | | | | | |
| Total | | 102.02 | | 26.52 | |

* Percent Solids of Coating is ˜26

### EXAMPLE 4*

| | | | | Solid | % in Dry |
|---|---|---|---|---|---|
| Product | Supplier | Mass | % Solids | Mass(g) | Composition |
| MEK | Aldrich | 53 | | | |
| UCARMAG | Dow | 2 | 100 | 2 | 7.5 |
| 527 | | | | | |
| PVP/VA | ISP | 45 | 50 | 22.5 | 22.1 |
| E-535 | | | | | |
| Boehmite | Sasol | 2 | 100 | 2 | 7.5 |
| (DISPAL | | | | | |
| 18N4-80) | | | | | |
| Surfadone | ISP | 0.02 | 100 | 0.02 | 0.1 |
| LP-100 | | | | | |
| Total | | 102.02 | | 26.52 | |

* Percent Solids of Coating is ˜26

### EXAMPLE 5*

| | | | | Solid | % in Dry |
|---|---|---|---|---|---|
| Product | Supplier | Mass | % Solids | Mass(g) | Composition |
| MEK | Aldrich | 53 | | | |
| UCAR | Dow | 2 | 100 | 2 | 7.5 |
| VROH | | | | | |
| PVP/VA | ISP | 45 | 50 | 22.5 | 22.1 |
| E-535 | | | | | |
| Boehmite | Sasol | 2 | 100 | 2 | 7.5 |
| (DISPAL | | | | | |
| 18N4-80) | | | | | |
| Surfadone | ISP | 0.02 | 100 | 0.02 | 0.1 |
| LP-100 | | | | | |
| Total | | 102.02 | | 26.52 | |

* Percent Solids of Coating is ˜26

While the invention has been described with particular reference to certain embodiments thereof, it will be understood that changes and modifications may be made which are within the skill of the art. Accordingly, it is intended to be bound only by the following claims, in which:

What is claimed is:

1. An inkjet-receptive article comprising a substrate having a coating thereon comprising a vinyl lactam polymer or copolymer and a polymer resin diluent coated from a non-aqueous solvent.

2. An inkjet-receptive article according to claim 1 wherein said vinyl lactam polymer is a polyvinylpyrrolidone polymer or copolymer.

3. An inkjet-receptive article according to claim 1 wherein said vinyl lactam copolymer is polyvinylpyrrolidone-vinyl acetate.

4. An inkjet-receptive article according to claim 1 wherein said substrate is a plastic.

5. An inkjet-receptive article according to claim 4 wherein said substrate is a vinyl, polyester, polyolefin, or paper.

6. An inkjet-receptive article according to claim 1 which includes a pigment.

7. An inkjet-receptive article according to claim 1 wherein said pigment is silica or barium sulfate, or mixtures thereof.

8. An inkjet-receptive article according to claim 7 wherein said pigment is present in an amount of up to 30 wt. % of the coating.

9. An inkjet-receptive article according to claim 8 wherein said pigment is present in an amount of 5-15 wt. % of the coating.

10. An inkjet-receptive article according to claim 1 which includes a diluent.

11. An inkjet-receptive article according to claim 10 wherein said diluent is present in an amount of up to 40 wt. % of the coating.

12. An article according to claim 11 wherein said diluent is a powdered polymer resin.

13. An article according to claim 12 wherein said diluent is present in an amount of 5-15 wt. %.

14. An article according to claim 1 which includes a surfactant.

15. An article according to claim 14 wherein said surfactant is present in amount of up to 4 wt. % of the coating.

16. A solvent-based composition for forming an inkjet-receptive coating on a substrate comprising:
(a) a vinyl lactam polymer or copolymer,
(b) a non-aqueous solvent,
(c) optionally a pigment, and
(d) a polymer resin diluent.

17. A solvent-based composition according to claim 16 which includes a surfactant.

18. A solvent-based composition according to claim 16 having a % solids of 8-50%.

19. A solvent-based composition according to claim 16 wherein said % solids is 20-30%.

20. A solvent-based composition according to claim 16 having a Brookfield viscosity of 50-1500 cPs.

21. A solvent-based composition according to claim 20 wherein said viscosity is 60-500 cPs.

22. A solvent-based composition according to claim 14 wherein (a) is a powder or is in a non-aqueous solution.

23. A solvent-based composition according to claim 16 wherein (b) is methyl ethyl ketone, isopropanol, ethanol, or mixtures thereof.

24. A solvent-based composition according to claim 16 wherein (c) is silicon dioxide

25. A solvent-based composition according to claim 16 wherein (c) is a resin or mixtures thereof.

26. A solvent-based composition according to claim 16 wherein (a) is a polyvinylpyrrolidone polymer or-copolymer.

27. A solvent-based composition according to claim 26 which is a polyvinylpyrrolidone-vinyl acetate copolymer.
